(19) United States
(12) Patent Application Publication
(10) Pub. No.: US 2022/0219656 A1
(43) Pub. Date: Jul. 14, 2022

(54) VEHICLE CONTROL DEVICE

(71) Applicant: TOYOTA JIDOSHA KABUSHIKI KAISHA, Toyota-shi (JP)

(72) Inventors: Tomotaka ASANO, Susono-shi (JP); Mitsutaka TANIMOTO, Numazu-shi (JP); Takahiro KOJO, Gotemba-shi (JP); Tomomichi NAKAMURA, Sunto-gun (JP); Taisuke YASUTOMI, Ebina-shi (JP)

(21) Appl. No.: 17/554,324

(22) Filed: Dec. 17, 2021

(30) Foreign Application Priority Data
Jan. 8, 2021 (JP) 2021-002190

(51) Int. Cl. B60T 8/1761; B60T 8/17; B60T 17/18; B60W 60/00

(52) U.S. Cl. CPC B60T 8/1761; B60T 8/1701; B60T 17/18; B60W 60/00186; B60T 2230/02; B60W 2710/182; B60T 2210/12; B60W 2520/125; B60W 2552/15; B60W 2552/40; B60T 2210/20

(57) ABSTRACT

A vehicle control device includes an automatic driving control device configured to execute automatic driving control on a vehicle, and an anti-lock braking system configured to control a longitudinal slip ratio of wheels of the vehicle to be equal to or smaller than a threshold during braking of the vehicle. The automatic driving control to be executed by the automatic driving control device includes braking force control for changing a braking force to be applied to the wheels of the vehicle depending on a target deceleration set without being based on a deceleration request by a driver. The automatic driving control device is configured to, when a failure of the anti-lock braking system is detected during execution of the automatic driving control on the vehicle, set the target deceleration in the braking force control to a value equal to or smaller than an upper limit deceleration value.

### CROSS-REFERENCE TO RELATED APPLICATION

This application claims priority to Japanese Patent Application No. 2021-002190 filed on Jan. 8, 2021, incorporated herein by reference in its entirety.

### BACKGROUND

### 1. Technical Field

The present disclosure relates to a vehicle control device. The present disclosure is used, for example, for controlling a vehicle including an anti-lock braking system and capable of automatic driving.

### 2. Description of Related Art

There is known anti-lock control for preventing wheels from locking by controlling an increase/decrease in a brake pressure on the wheels when determination is made that the wheels have a tendency to lock. For example, Japanese Patent No. 2917491 (JP 2917491 B) describes control to be executed when a failure occurs in a sensor such as a wheel speed sensor or a vehicle body deceleration sensor during anti-lock control. Specifically, in this control, the amount of increase in the brake pressure and the number of times of increase in the brake pressure are set based on an immediately preceding road surface friction coefficient estimated based on an output signal of the sensor before the failure. The brake pressure of the wheels is gradually increased based on the set amount of pressure increase and the set number of pressure increases.

### SUMMARY

If the anti-lock braking system fails during the execution of automatic driving control by driving assistance or autonomous driving and the anti-lock control does not operate, a deceleration operation under braking force control may be excessive during the automatic driving and the wheels may be locked.

The present disclosure provides an improved vehicle control device that can suppress an excessive deceleration operation during automatic driving even when a failure occurs in an anti-lock braking system.

A first aspect of the present disclosure relates to a vehicle control device. The vehicle control device includes an automatic driving control device configured to execute automatic driving control on a vehicle, and an anti-lock braking system configured to control a longitudinal slip ratio of wheels of the vehicle to be equal to or smaller than a threshold during braking of the vehicle. The automatic driving control to be executed by the automatic driving control device includes braking force control for changing a braking force to be applied to the wheels of the vehicle depending on a target deceleration set without being based on a deceleration request by a driver. The automatic driving control device is configured to, when a failure of the anti-lock braking system is detected during execution of the automatic driving control on the vehicle, set the target deceleration in the braking force control to a value equal to or smaller than an upper limit deceleration value.

In the first aspect, the automatic driving control device may be configured to, when the failure of the anti-lock braking system is detected during execution of the braking force control and the target deceleration set at a time of detection of the failure exceeds the upper limit deceleration value, reduce the target deceleration to the upper limit deceleration value while keeping an amount of decrease in the target deceleration per unit time at a value equal to or smaller than a threshold.

In the first aspect, the automatic driving control device may be configured to create a target traveling route, and execute automatic traveling control for causing the vehicle to automatically travel along the target traveling route. The automatic driving control device may be configured to, when a vehicle traveling ahead of the vehicle or a vehicle traveling around the vehicle in a lane neighboring a lane of the vehicle is detected during execution of the automatic traveling control, start the braking force control with the target deceleration set to the upper limit deceleration value.

In the first aspect, the automatic driving control device may be configured to, when the target deceleration is limited to the value equal to or smaller than the upper limit deceleration value during the execution of the automatic driving control, keep the limit until the automatic driving control is terminated.

In the first aspect, the automatic driving control device may be configured to, when the failure of the anti-lock braking system is detected during the execution of the automatic driving control and is no longer detected before the automatic driving control is terminated, increase the upper limit deceleration value while keeping an amount of increase in the upper limit deceleration value per unit time at a value equal to or smaller than an increase threshold.

In the first aspect, the upper limit deceleration value may be set based on at least one of a lateral acceleration of the vehicle, a turning state of the vehicle, a gradient of a downhill road, and a road surface p.

A second aspect of the present disclosure relates to a vehicle control device. The vehicle control device includes an automatic driving control device configured to execute automatic driving control on a vehicle, and an anti-lock braking system configured to control a longitudinal slip ratio of wheels of the vehicle to be equal to or smaller than a set threshold during braking of the vehicle. The automatic driving control device is configured to execute braking force control for changing a braking force to be applied to the wheels of the vehicle depending on a set target deceleration. The automatic driving control device is configured to, when a failure of the anti-lock braking system is detected during execution of the automatic driving control on the vehicle, set the target deceleration in the braking force control to a value equal to or smaller than an upper limit deceleration value.

According to the first aspect and the second aspect of the present disclosure, when the failure of the anti-lock braking system is detected, the target deceleration in the braking force control in the automatic driving is limited to the upper limit deceleration value. As a result, even when the failure occurs in the anti-lock braking system, an excessive deceleration operation can be suppressed and a wheel lock can be avoided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration example of a vehicle control system according to a first embodiment of the present disclosure and a vehicle to which the vehicle control system is applied;

FIG. 2 is a flowchart illustrating a control routine to be executed by an automatic driving control device according to the first embodiment of the present disclosure;

FIG. 3 is a diagram illustrating an outline of control to be executed by a vehicle control system according to a second embodiment of the present disclosure;

FIG. 4 is a flowchart illustrating a control routine to be executed by an automatic driving control device according to the second embodiment of the present disclosure;

FIG. 5 is a flowchart illustrating a control routine to be executed by an automatic driving control device according to a third embodiment of the present disclosure;

FIG. 6 is a diagram schematically illustrating a relationship between an upper limit deceleration value to be set in automatic driving control according to a fourth embodiment of the present disclosure and each of a lateral acceleration, a turn, and a gradient of a downhill road; and

FIG. 7 is a diagram schematically illustrating a relationship between the upper limit deceleration value to be set in the automatic driving control according to the fourth embodiment of the present disclosure and a road surface p.

### DETAILED DESCRIPTION OF EMBODIMENTS

Embodiments of the present disclosure will be described below with reference to the drawings. In the drawings, the same or corresponding portions will be represented by the same reference signs, and their description will be simplified or omitted.

### 1. First Embodiment

### 1-1. Outline of Automatic Driving Control

A vehicle control system according to the present embodiment is a vehicle control device configured to execute automatic driving control for causing a vehicle to travel automatically. The automatic driving control according to the present embodiment is driving assistance control or autonomous driving control. By the automatic driving control according to the present embodiment, automatic driving of, for example, Level 2 or higher in the level definition of the Society of Automotive Engineers (SAE) is realized.

The automatic driving control is executed based on a traveling plan of the vehicle. The traveling plan is created to ensure that the vehicle travels safely along an optimal route to a destination in accordance with traffic rules. The traveling plan includes actions of, for example, keeping a current traveling lane and changing lanes. In the automatic driving control, a target traveling route that is a final traveling path to be followed by the vehicle is generated based on the traveling plan. To cause the vehicle to follow the target traveling route in the automatic driving control, a deviation (lateral deviation, yaw angle deviation, speed deviation, etc.) between the vehicle and the target traveling route is calculated, and steering, braking, or driving of the vehicle is controlled to reduce the deviation.

### 1-2. Configuration and Functions of Vehicle Control System

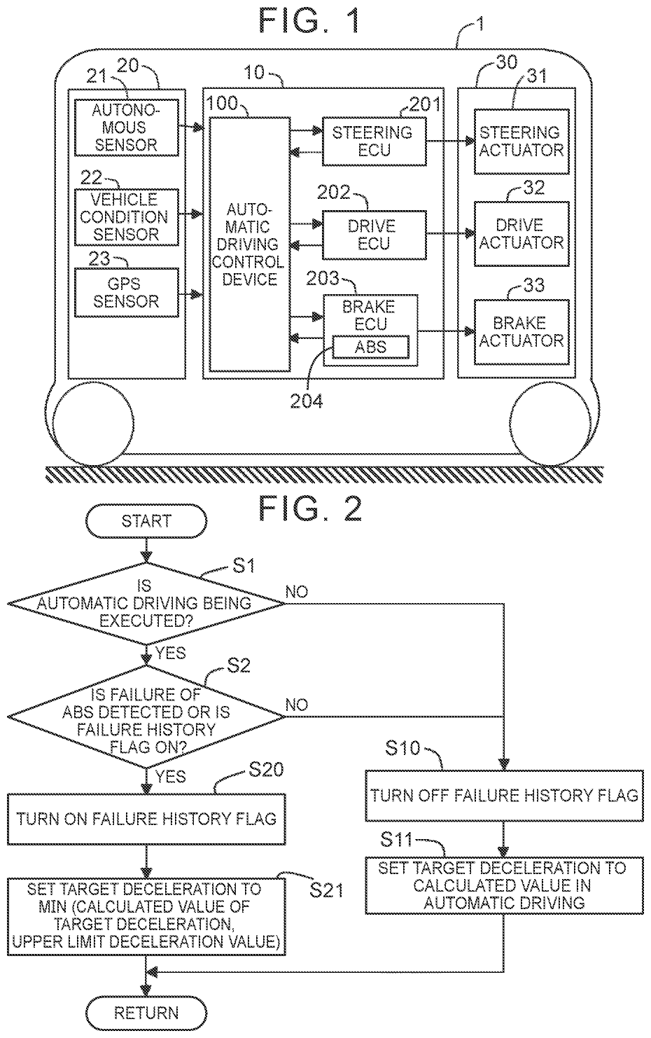

FIG. 1 is a diagram illustrating a configuration example of a vehicle control system 10 according to the present embodiment and a vehicle 1 to which the vehicle control system 10 is applied. The vehicle 1 includes the vehicle control system 10, an in-vehicle sensor 20 that inputs information to the vehicle control system 10, and a vehicle actuator 30 that operates in response to a signal output from the vehicle control system 10.

The in-vehicle sensor 20 includes an autonomous sensor 21, a vehicle condition sensor 22, and a Global Positioning System (GPS) sensor 23. The autonomous sensor 21 acquires information about the surrounding environment of the vehicle 1, and includes sensors such as a camera, a millimeter-wave radar, and a Light Detection And Ranging (LiDAR) sensor. Processes such as detection of an object such as a preceding vehicle around the vehicle 1, measurement of a relative position and a relative speed of the detected object to the vehicle 1, and recognition of the shape of the detected object are executed based on the information obtained by the autonomous sensor 21. The vehicle condition sensor 22 acquires information about motion of the vehicle 1, and includes sensors such as a wheel speed sensor, an acceleration sensor, a yaw rate sensor, a steering angle sensor, and a stroke sensor. The GPS sensor 23 is used to acquire information about a current position of the vehicle 1.

The vehicle actuator 30 includes a steering actuator 31 for steering wheels, a drive actuator 32 for driving the vehicle 1, and a brake actuator 33 for braking the vehicle 1. For example, the steering actuator 31 includes a power steering system, a steer-by-wire steering system, and a rear wheel steering system. For example, the drive actuator 32 includes an engine, an electric vehicle (EV) system, and a hybrid system. For example, the brake actuator 33 includes a hydraulic brake and a power regenerative brake. The hydraulic brake includes a brake caliper, a rotor, a pad, a hydraulic pipe, and the like. The regenerative brake includes an electric motor or the like.

The vehicle control system 10 includes an automatic driving control device 100, a steering electronic control unit (ECU) 201, a drive ECU 202, and a brake ECU 203. Each of these control devices (100, 201 to 203) is an independent ECU, and includes at least a processor and a storage device. The storage device includes a main storage device and an auxiliary storage device. Necessary information is input and output between the automatic driving control device 100 and each of the ECUs 201 to 203 via wired communication such as controller area network (CAN) communication or Ethernet (registered trademark) communication or wireless communication.

The automatic driving control device 100 is responsible for management and control on automatic driving of the vehicle 1. The storage device of the automatic driving control device 100 stores an automatic driving control program that can be executed by the processor and various types of data related to the automatic driving control program. When the automatic driving control program is executed by the processor, the processor acquires sensor information from the in-vehicle sensor 20, recognizes a position of the vehicle 1 on a map, and recognizes a situation around the vehicle 1. The processor generates a target traveling route of the vehicle 1 during the automatic driving based on the position of the vehicle 1 on the map and the situation around the vehicle 1, and determines amounts of steering, driving, and braking of the vehicle 1 to cause the vehicle 1 to follow the target traveling route.

The steering ECU 201 controls the steering actuator 31 of the vehicle. The drive ECU 202 controls the drive actuator 32. The brake ECU 203 controls the brake actuator 33. When the automatic driving control mediates, the steering ECU 201, the drive ECU 202, and the brake ECU 203 receive control signals from the automatic driving control device 100 to control steering, driving, and braking operations of the vehicle 1.

The brake ECU 203 includes an anti-lock braking system (hereinafter referred to as “ABS”) 204. The ABS 204 executes anti-lock control to prevent the wheels from locking during braking of the vehicle 1. Specifically, the ABS 204 calculates a longitudinal slip ratio of the wheels based on an estimated vehicle body speed and a wheel speed, and reduces a braking force when the slip ratio exceeds a threshold. That is, when the brake actuator is, for example, a hydraulic brake, a brake fluid pressure of the wheels is reduced.

### 1-3. Outline of Control in Event of ABS Failure

In the present embodiment, the automatic driving control to be executed by the automatic driving control device 100 includes braking force control for changing a braking force to be applied to the wheels of the vehicle depending on a target deceleration set without being based on a deceleration request by a driver.

The control to be executed by the automatic driving control device 100 includes failure control to be executed when a failure of the ABS 204 is detected during the automatic driving. Specifically, when a failure of the ABS 204 is detected during the automatic driving control of the vehicle 1, the target deceleration to be set in the automatic driving is limited to an upper limit deceleration value. That is, the target deceleration during the automatic driving control is a smaller one of the upper limit deceleration value and a calculated value of the target deceleration calculated based on the automatic driving control program. The upper limit deceleration value is a preset value to prevent the wheels from locking. When the automatic driving control is not being executed, the upper limit deceleration value is not set.

### 1-4. Specific Control Operation

FIG. 2 is a flowchart illustrating a specific control routine to be executed by the automatic driving control device 100 according to the present embodiment. The failure control on the ABS 204 to be executed by the automatic driving control device will be described below in detail with reference to the flowchart of FIG. 2. The control routine of FIG. 2 is repeatedly executed at regular control intervals.

In the process of FIG. 2, determination is first made in Step S1 as to whether the automatic driving control of the vehicle 1 is being executed. When determination is made in Step S1 that the automatic driving control of the vehicle 1 is being executed, the process proceeds to S2.

In Step S2, determination is made as to whether a failure of the ABS 204 is detected or a failure history flag is ON. The failure history flag is turned ON by a process described later when the ABS 204 is diagnosed with failure, and is turned OFF when the automatic driving is terminated.

When the determination result in Step S1 or Step S2 is “NO”, that is, when the automatic driving control is not currently being executed or when the failure of the ABS 204 is not detected and the failure history flag is OFF, the process proceeds to Step S10.

In Step S10, the failure history flag of the ABS 204 is turned OFF. Next, the process proceeds to Step S11. No limit value is set for the target deceleration, and a calculated value of the target deceleration calculated in the automatic driving control is adopted as the target deceleration. That is, the target deceleration calculated by the automatic driving control device 100 based on the automatic driving control program can be used as it is. Then, the process of this routine is terminated.

When determination is made in Step S2 that the failure of the ABS 204 is detected or the failure history flag is ON, the process proceeds to Step S20. In Step S20, the failure history flag is turned ON.

In Step S21, the target deceleration in the automatic driving control is limited to a value equal to or smaller than the upper limit deceleration value. That is, in the deceleration control during the automatic driving control, a smaller one of the upper limit deceleration value and the calculated value of the target deceleration calculated in the automatic driving control is selected and used for the deceleration control during the automatic driving control. Then, the process of this routine is terminated.

According to the vehicle control system 10 of the present embodiment described above, when the ABS 204 has failed, the deceleration of the automatic driving control is limited. As a result, an excessive deceleration operation during the automatic driving can be suppressed, and a wheel lock can be prevented.

### 1-5. Other Configuration Examples of Failure Control

The present embodiment is directed to the case where the target deceleration in the automatic driving control is limited when the ABS 204 is diagnosed with failure. For example, in a case where the vehicle 1 includes a system such as an electronic brake force distribution (EBD) device or a vehicle stability control (VSC) device, the target deceleration may be set to the upper limit deceleration value when a failure is detected by referring to a failure diagnosis made by the system.

When the failure of the ABS 204 is caused by a power failure of the brake ECU 203, the failure of the ABS 204 cannot be reported to the automatic driving control device 100. In this case, as another example of the determination method, the failure of the ABS 204 may be detected and the failure control may be executed by referring to a result of detection of the power failure. As another example, the failure of the ABS 204 may be detected and the failure control may be executed by referring to a result of detection of interruption of reception from the brake ECU 203. The present disclosure is not limited to these examples. When the failure of the ABS 204 cannot be detected by the automatic driving control device 100 but can be detected by referring to other detection results, the failure control may be executed accordingly.

In the present embodiment, once the failure of the ABS 204 is detected during the execution of the automatic driving control, the failure history flag is turned ON and the limit for the target deceleration by the upper limit deceleration value is kept until the automatic driving control is terminated. The present disclosure is not limited to this configuration. For example, when the failure of the ABS 204 is no longer detected during the execution of the automatic driving control, the upper limit deceleration value may gradually be increased and the limit by the upper limit deceleration value may finally be terminated.

The gradual increase in the upper limit deceleration value means that the upper limit deceleration value is increased within a range in which the amount of increase per unit time does not exceed an increase threshold. This increase includes both a case where the upper limit deceleration value is increased by an increasing function and a case where the upper limit deceleration value is increased stepwise. Examples of the stepwise increase include a method involving an increase by a predetermined amount in every control cycle in which the target deceleration is calculated in the automatic driving control.

Alternatively, when the deceleration control is not being executed in a case where the failure of the ABS 204 is no longer detected before the automatic driving control is terminated, the limit by the upper limit deceleration value may be terminated immediately and the calculated value of the target deceleration calculated in the automatic driving control may directly be adopted as the target deceleration. In a case where the deceleration control is being executed under the automatic driving control when the failure of the ABS 204 is no longer detected, it is desirable to keep the failure control in which the target deceleration is limited to a value equal to or smaller than the upper limit deceleration value and terminate the limit by the upper limit deceleration value after the termination of the deceleration control.

### 2. Second Embodiment

The configurations of a vehicle 1 and a vehicle control system 10 of a second embodiment are the same as the configurations of the first embodiment described with reference to FIG. 1. The vehicle control system 10 of the second embodiment executes control different from the control in the first embodiment in a case where the target deceleration of the automatic driving control has already exceeded the upper limit deceleration value when the failure of the ABS 204 is detected.

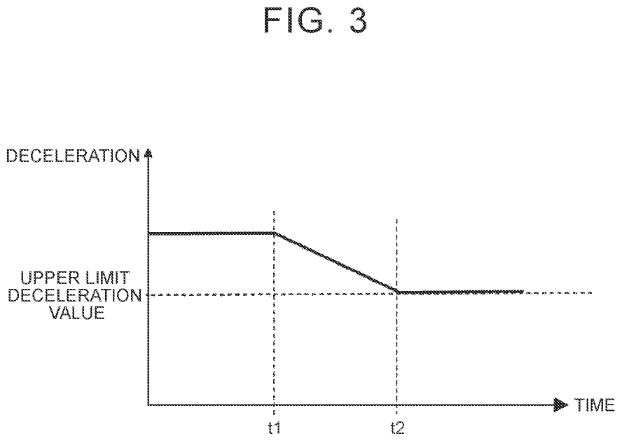

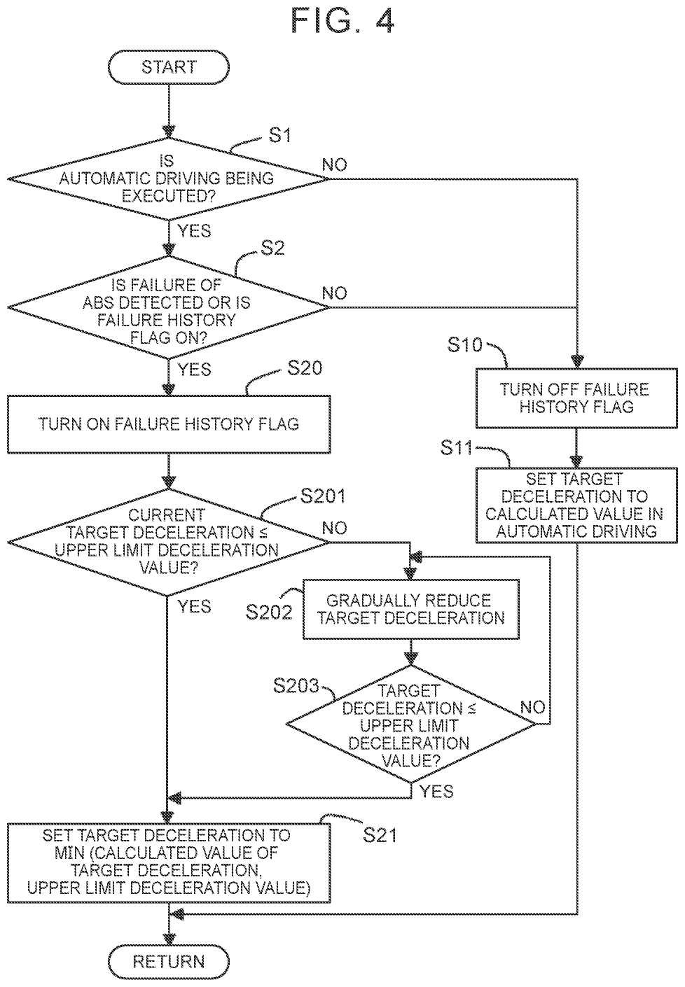

FIG. 3 is a diagram illustrating a deceleration control example to be executed when the target deceleration at the time of detection of the failure of the ABS 204 exceeds the upper limit deceleration value during the automatic driving control. In the example illustrated in FIG. 3, the failure of the ABS 204 is detected at a time t1 during the automatic driving control. At this time, the target deceleration in the automatic driving control has already exceeded the upper limit deceleration value. In the present embodiment, as in the example of FIG. 3, the target deceleration is controlled to start decreasing from the time t1 when the failure is detected, and gradually decrease until a time t2 when the target deceleration decreases to the upper limit deceleration value.

The “gradual decrease” means that the target deceleration decreases while keeping the amount of decrease in the target deceleration per unit time at a value equal to or smaller than a predetermined threshold. This decrease includes a case where the target deceleration decreases by a decreasing function and a case where the target deceleration decreases stepwise. Examples of the stepwise decreasing method include a method involving a decrease in the target deceleration by a predetermined amount in every calculation cycle in which the target deceleration is calculated in the automatic driving control.

FIG. 4 is a flowchart illustrating a control routine to be executed by an automatic driving control device 100 according to the present embodiment. The control routine of FIG. 4 is the same as the control routine of FIG. 2 except that processes of Steps S201 to S203 are provided between Steps S20 and S21 of the control routine of FIG. 2.

Specifically, after the failure history flag is turned ON in Step S20, determination is made in Step S201 as to whether a current target deceleration in the automatic driving is equal to or smaller than the upper limit deceleration value. The case where the current deceleration is smaller than the upper limit deceleration value includes a case where the vehicle 1 is not decelerated currently, that is, the deceleration is 0 or smaller. When determination is made in Step S201 that the current target deceleration is equal to or smaller than the upper limit deceleration value, the process proceeds to Step S21, and the target deceleration is limited to a value equal to or smaller than the upper limit deceleration value.

When determination is made in Step S201 that the current target deceleration is larger than the upper limit deceleration value, the process proceeds to Step S202. In Step S202, the target deceleration in the automatic driving is gradually reduced toward the upper limit deceleration value.

In Step S203, determination is made as to whether the target deceleration is equal to or smaller than the upper limit deceleration value. When determination is made in Step S203 that the target deceleration is larger than the upper limit deceleration value, the process returns to Step S202 to continue the process of reducing the target deceleration. The process of Step S202 and the determination process of Step S203 are continued until determination is made in Step S203 that the target deceleration is equal to or smaller than the upper limit deceleration value. When determination is made in Step S203 that the target deceleration is equal to or smaller than the upper limit deceleration value, the process proceeds to Step S21, and the target deceleration is limited to the upper limit deceleration value.

According to the vehicle control system 10 of the second embodiment described above, even when the failure of the ABS 204 is detected in a state in which the deceleration is already larger than the upper limit deceleration value during the automatic driving, a sudden decrease in the deceleration can be suppressed and the deceleration can be changed gently.

### 3. Third Embodiment

The configuration of a vehicle 1 of a third embodiment is the same as the configuration of the vehicle 1 of the first embodiment illustrated in FIG. 1. An automatic driving control device 100 of the third embodiment can execute automatic traveling control for causing the vehicle 1 to automatically travel along a target traveling route. The automatic driving control device 100 acquires surrounding information of the vehicle 1 acquired by the autonomous sensor 21 during the automatic traveling control, and determines that a preceding vehicle is present when a vehicle traveling ahead of the vehicle 1 is detected. When a vehicle traveling around the vehicle 1 is detected in a lane neighboring the lane where the vehicle 1 is traveling, determination is made that a preceding neighboring-lane vehicle is present.

When determination is made that a preceding vehicle or a preceding neighboring-lane vehicle is present and the failure of the ABS 204 is detected during the automatic driving control, the target deceleration is set to the upper limit deceleration value regardless of whether the deceleration control is currently executed, and the deceleration control of the vehicle 1 is started.

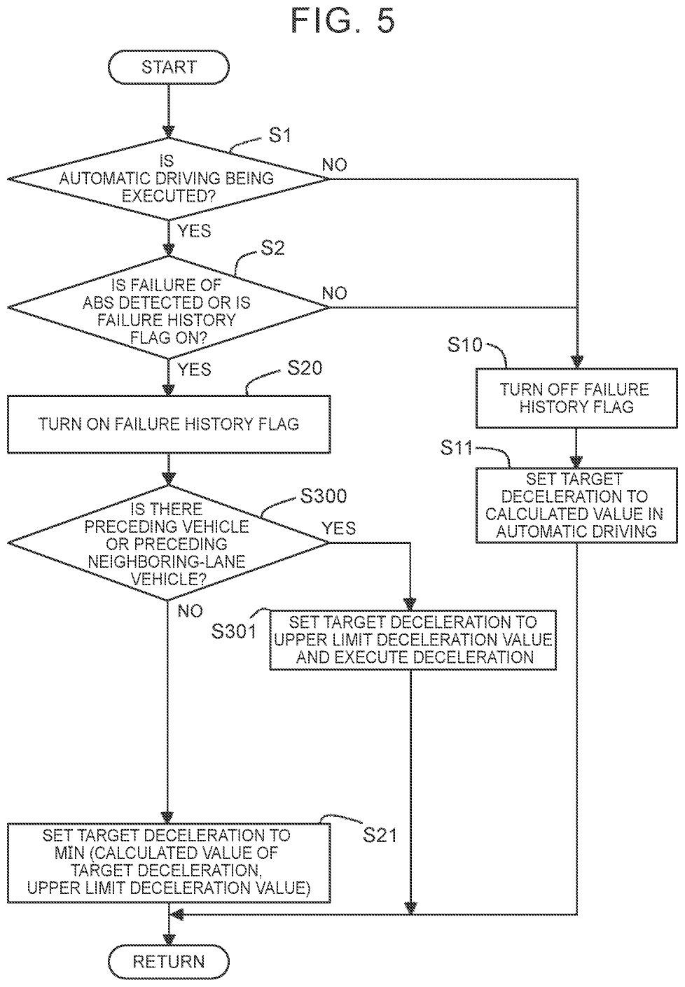

FIG. 5 is a flowchart illustrating a control routine to be executed by the automatic driving control device 100 according to the present embodiment. The control routine of FIG. 5 is the same as the control routine of FIG. 2 except that processes of Steps S300 and S301 are provided between Steps S20 and S21.

In the control routine of FIG. 5, after the failure history flag is turned ON in Step S20, determination is made in Step S300 as to whether a preceding vehicle or a preceding neighboring-lane vehicle is detected. When a preceding vehicle or a preceding neighboring-lane vehicle is not detected in Step S300, the process proceeds to Step S21, and the target deceleration is limited to a value equal to or smaller than the upper limit deceleration value.

When determination is made in Step S300 that a preceding vehicle or a preceding neighboring-lane vehicle is detected, the process proceeds to Step S301. In Step S301, the target deceleration of the automatic driving control is set to the upper limit deceleration value, and deceleration is started immediately. Then, the process of this routine is terminated.

According to the control in the third embodiment, the deceleration is immediately started when a vehicle traveling around the vehicle 1 is detected while the automatic driving control is being executed and the ABS 204 has a failure. By the early deceleration described above, it is possible to reduce the risk of collision while preventing the wheel lock, thereby further improving the safety of the automatic driving.

### 4. Fourth Embodiment

A vehicle 1 according to the present embodiment has the same configuration as that of the vehicle 1 of the first embodiment described with reference to FIG. 1. Failure control on the ABS 204 in the present embodiment is the same as the control according to any one of the first to third embodiments except that the upper limit deceleration value for the target deceleration of the automatic driving control is not set to the predetermined constant but is set based on a lateral acceleration.

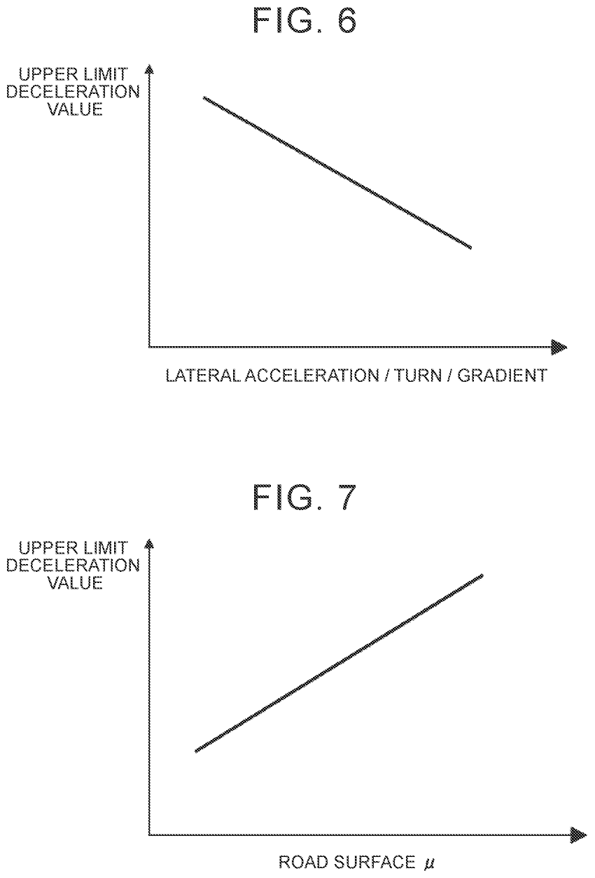

FIG. 6 is a diagram schematically illustrating a relationship between the upper limit deceleration value to be set in the present embodiment and the lateral acceleration. As illustrated in FIG. 6, in the present embodiment, the upper limit deceleration value is set smaller when the lateral acceleration is large than when the lateral acceleration is small. As illustrated in FIG. 6, the upper limit deceleration value may be set to decrease by a function based on the lateral acceleration. The relationship between the lateral acceleration and the upper limit deceleration value may be defined by a map or the like. In this case, the relationship between the lateral acceleration and the upper limit deceleration value is set so that the upper limit deceleration value set when the lateral acceleration belongs to a certain range is larger than the upper limit deceleration value set when the lateral acceleration belongs to another range larger than the certain range.

When the lateral acceleration is large, the wheel lock is likely to occur in a rear inner wheel of turning due to a load loss. By reducing the upper limit deceleration value based on the lateral acceleration, it is possible to avoid the occurrence of the wheel lock more effectively. When the lateral acceleration is small, the target deceleration can appropriately be increased by setting a large upper limit deceleration value.

Similarly, a turning state may be detected and the upper limit deceleration value may be changed based on the turning state. Similarly to the case of the lateral acceleration, the upper limit deceleration value is set smaller when the turn is large than when the turn is small.

Similarly, when the vehicle is traveling on a downhill road, the upper limit deceleration value may be changed based on a gradient of the downhill road. When the gradient of the downhill road is large, a rear load is likely to decrease during braking, and the wheel lock is likely to occur. Therefore, as illustrated in FIG. 6, the upper limit deceleration value is set smaller when the gradient is large than when the gradient is small. As a result, the occurrence of the wheel lock is suppressed effectively.

In a case where the vehicle control system includes means for estimating a road surface p, the upper limit deceleration value may be changed based on the road surface p. As illustrated in FIG. 7, the upper limit deceleration value is set larger when the road surface p is large than when the road surface p is small.

By changing the upper limit deceleration value based on the driving condition of the vehicle or the condition of the road surface as described above, it is possible to prevent the wheel lock and execute appropriate deceleration control more reliably.

When the number, quantity, amount, range, or any other numerical value of each element is described in the embodiments described above, the present disclosure is not limited to the described numerical value unless otherwise noted or unless the numerical value is definitely determined in theory. The structures and the like described in the embodiments described above are not necessarily essential to the present disclosure unless otherwise noted or unless the structures and the like are definitely needed in theory.

What is claimed is:

1. A vehicle control device comprising:
an automatic driving control device configured to execute automatic driving control on a vehicle; and
an anti-lock braking system configured to control a longitudinal slip ratio of wheels of the vehicle to be equal to or smaller than a threshold during braking of the vehicle, wherein
the automatic driving control to be executed by the automatic driving control device includes braking force control for changing a braking force to be applied to the wheels of the vehicle depending on a target deceleration set without being based on a deceleration request by a driver, and
the automatic driving control device is configured to, when a failure of the anti-lock braking system is detected during execution of the automatic driving control on the vehicle, set the target deceleration in the braking force control to a value equal to or smaller than an upper limit deceleration value.

2. The vehicle control device according to claim 1, wherein the automatic driving control device is configured to, when the failure of the anti-lock braking system is detected during execution of the braking force control and the target deceleration set at a time of detection of the failure exceeds the upper limit deceleration value, reduce the target deceleration to the upper limit deceleration value while keeping an amount of decrease in the target deceleration per unit time at a value equal to or smaller than a threshold.

3. The vehicle control device according to claim 1, wherein the automatic driving control device is configured to:
create a target traveling route;
execute automatic traveling control for causing the vehicle to automatically travel along the target traveling route; and
start the braking force control with the target deceleration set to the upper limit deceleration value when a vehicle traveling ahead of the vehicle or a vehicle traveling around the vehicle in a lane neighboring a lane of the vehicle is detected during the execution of the automatic traveling control.

4. The vehicle control device according to claim 1, wherein the automatic driving control device is configured to, when the target deceleration is limited to the value equal to or smaller than the upper limit deceleration value during the execution of the automatic driving control, keep the limit until the automatic driving control is terminated.

5. The vehicle control device according to claim 1, wherein the automatic driving control device is configured to, when the failure of the anti-lock braking system is detected during the execution of the automatic driving control and is no longer detected before the automatic driving control is terminated, increase the upper limit deceleration value while keeping an amount of increase in the upper limit deceleration value per unit time at a value equal to or smaller than an increase threshold.

6. The vehicle control device according to claim 1, wherein the upper limit deceleration value is set based on at least one of a lateral acceleration of the vehicle, a turning state of the vehicle, a gradient of a downhill road, and a road surface p.

7. A vehicle control device comprising:
an automatic driving control device configured to execute automatic driving control on a vehicle; and
an anti-lock braking system configured to control a longitudinal slip ratio of wheels of the vehicle to be equal to or smaller than a set threshold during braking of the vehicle, wherein
the automatic driving control device is configured to
execute braking force control for changing a braking force to be applied to the wheels of the vehicle depending on a set target deceleration, and
set the target deceleration in the braking force control to a value equal to or smaller than an upper limit deceleration value when a failure of the anti-lock braking system is detected during execution of the automatic driving control on the vehicle.
